(19) United States
(12) Patent Application Publication
(10) Pub. No.: US 2026/0278830 A1
(43) Pub. Date: Sep. 17, 2026

(54) LIGHT SENSING DEVICE CAPABLE OF IDENTIFYING ABSOLUTE POSITIONS, LIGHT SENSING SYSTEM INCLUDING THE SAME AND OPERATING METHOD THEREOF

(71) Applicant: PIXART IMAGING INC., Hsin-Chu County (TW)

(72) Inventors: Chung-Ting YANG, Hsin-Chu County (TW); Tzu-Yu CHEN, Hsin-Chu County (TW); Chun-Chen CHEN, Hsin-Chu County (TW)

(21) Appl. No.: 19/078,283

(22) Filed: Mar. 13, 2025

(51) Int. Cl. G06T 7/73; G06T 7/246; G06T 7/60

(52) U.S. Cl. CPC G06T 7/74; G06T 7/248; G06T 7/60; G06T 2207/20081

(57) ABSTRACT

There is provided a light sensing device for identifying an absolute position of a shaft. The light sensing device includes a light source, a light sensor, a memory and a processor. The light source is used to illuminate the shaft. The light sensor is used to acquire image frames of the shaft. The memory is used to record multiple image features of multiple positioning points and associated buffer regions of the multiple positioning points. The processor is used to calculate a current image feature of a current image frame acquired by the light sensor, and compare the current image feature with the multiple image features to confirm a current position of the shaft.

### FIELD OF THE DISCLOSURE

This disclosure generally relates to an optical positioning technology and, more particularly, to a light sensing device that identifies absolute positions of a shaft based on multiple image features recorded in a learning stage and a current image feature of a current image and associated buffer regions acquired in an operating stage to output a corresponding control signal, and a light sensing system and operating method thereof.

### BACKGROUND OF THE DISCLOSURE

Conventionally, means for optical encoding generally needs to process a working surface to have markers with a specific density for reflecting light or light penetration. Or the encoding is implemented by arranging light sources in a particular way or controlling a light emitting sequence of the light sources.

However, in these conventional technologies a special processing has to be performed on the working surface previously such that the application thereof is limited. Meanwhile, in order to obtain an accurate detection result, the processing of the working surface becomes complicated so that the difficulty of applying this technology also becomes higher.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an optical positioning system that does not require arranging recognition markers on a surface under detection, and an operating method of the optical positioning system.

The present disclosure further provides a light sensing device that adjusts a comparison range of reference image features corresponding to a rotation speed of a shaft to accordingly output a control signal corresponding to predetermined angles/positions timely according to a part of image features, and a light sensing system including the same and an operating method thereof.

The present disclosure provides a light sensing device including a light sensor, a memory and a processor. The light sensing device is used to identify an absolute position of a shaft. The light sensor is configured to acquire reflected light from the shaft to generate image frames. The memory is configured to record multiple image features of multiple positioning points of the shaft and associated buffer regions. The processor is configured to compare a current image feature of a current image frame with the multiple image features to identify a current angle of the shaft.

The present disclosure further provides a light sensing system including a light sensing device and a computer. The light sensing system is used to identify an absolute position of a shaft. The light sensing device is configured to output multiple image frames acquired corresponding to a start point and a whole cycle of the shaft in a learning stage. The computer is arranged outside of the light sensing device, and configured to divide multiple positioning points and associated buffer regions of the shaft according to an image frame associated with the start point and a frame rate, and calculate and record multiple image features of every positioning point and associated buffer regions.

The present disclosure further provides an operating method of a light sensing system. The light sensing system includes a light sensing device and an external computer, and is used to identify an absolute position of a shaft. The operating method includes the steps of: entering a learning stage to record multiple image features of multiple positioning points and associated buffer regions of the shaft; and entering an operating stage to compare a current image feature of a current image frame with the multiple image features to identify a current angle of the shaft.

### BRIEF DESCRIPTION OF DRAWINGS

Other objects, advantages, and novel features of the present disclosure will become more apparent from the following detailed description when taken in conjunction with the accompanying drawings.

FIG. 1 is a solid diagram of a light sensing device and a device under test according to one embodiment of the present disclosure.

FIG. 2 is a schematic block diagram of a light sensing system and a device under test according to one embodiment of the present disclosure.

FIG. 3 is a schematic diagram of image frames corresponding to different angles acquired by a light sensing device according to one embodiment of the present disclosure.

FIG. 4 is a schematic diagram of image features of an image frame and buffer regions recorded in a memory of a light sensing device according to one embodiment of the present disclosure.

FIG. 5 is flow chart of an operating method in a learning stage of a light sensing device according to a first embodiment of the present disclosure.

FIG. 6 is a flow chart of an operating method in a learning stage of a light sensing system according to a second embodiment of the present disclosure.

FIG. 7 is a flow chart of an operating method in an operating stage of a light sensing device and system according to one embodiment of the present disclosure.

FIG. 8 is a schematic diagram of an application of a light sensing device according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide an optical positioning system that does not require previously formed markers on a surface under detect (e.g., a shaft surface, but not limited thereto), and the optical positioning system uses any point of the surface under detect as a start point (or original point), and an operating method of the optical positioning system. Furthermore, in order to allow a light sensing device of the optical positioning system to be able to timely output a control signal corresponding to an absolute angle (or position) detected, the control signal is outputted when only a part of image features of one positioning point in a rotation direction of the shaft is detected. The control signal is not arranged to be outputted till all of the image features of the one positioning point are detected.

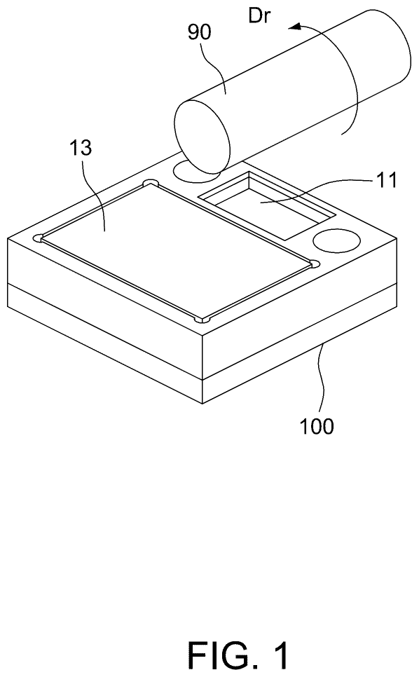

Please refer to FIG. 1, it is a solid diagram of a light sensing device 100 and a device under test (DUT) 90 according to one embodiment of the present disclosure, wherein the DUT 90 is shown by a shaft as an example, but the present disclosure is not limited to. The shaft 90 is, for example, a metal shaft, but not limited to metal, and the shaft 90 is rotated in a rotation direction Dr or a direction opposite to Dr.

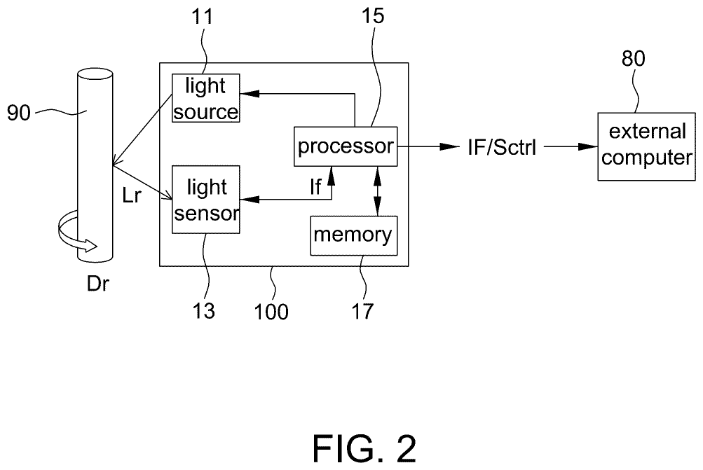

Please refer to FIG. 2, it is a schematic block diagram of a light sensing system and a device under test 90 according to one embodiment of the present disclosure. The light sensing system includes a light sensing device (e.g., 100 in FIG. 1) and an external computer 80. The light sensing device 100 includes a light source 11, a light sensor 13, a processor 15 and a memory 17. The light source 11, the light sensor 13, the processor 15 and the memory 17 may form a sensor chip that outputs (wired or wireless) a control signal Sctrl and/or image frames IF to the external computer 80 to cause the external computer 80 to perform corresponding controls. That is, the light sensing device 100 includes a wired or wireless communication interface to output the control signal Sctrl and/or image frames IF.

It should be mentioned that although FIGS. 1-2 show the light sensing device 100 being arranged opposite to a lateral side of the shaft 90 as an example, the present disclosure is not limited thereto. In other aspects, the light sensing device 100 may be arranged opposite to a top surface or a bottom surface (i.e. circular surface) of the shaft 90 as long as the light sensing device 100 is arranged opposite to a surface region of the shaft 90 that changes when the shaft 90 is rotating.

It should be mentioned that although FIG. 2 shows that the memory 17 is arranged outside of the processor 15, the present disclosure is not limited thereto. The memory 17 may be included in the processor 15 in other aspects.

The type of the external computer 80 (sometimes abbreviated as computer herein) is not particularly limited, e.g., selected from a notebook computer, a desktop computer, a tablet computer, a work station, a central control system or the like. After receiving the control signal Sctrl, the computer 80 performs predetermined controls, e.g., including controlling a display to show a current angle, controlling a light source to emit light, controlling a speaker to play a voice message, controlling a vibrator to vibrate, transmitting information to a mobile device or a wearable device depending an application thereof.

The light source 11 is, for example, a light emitting diode or a laser diode, and is used to illuminate the shaft 90 to generate reflected light Lr. For example, the light source 11 is controlled by the processor 15 to light on or light off. In a scenario having enough ambient light, the light source 11 is not lighted.

The light sensor 13 is, for example, a CMOS image sensor, a CCD image sensor or a single photon avalanche diode (SPAD) sensor that has a sensor array to acquire the reflected light Lr from the shaft 90 to generate image frames IF.

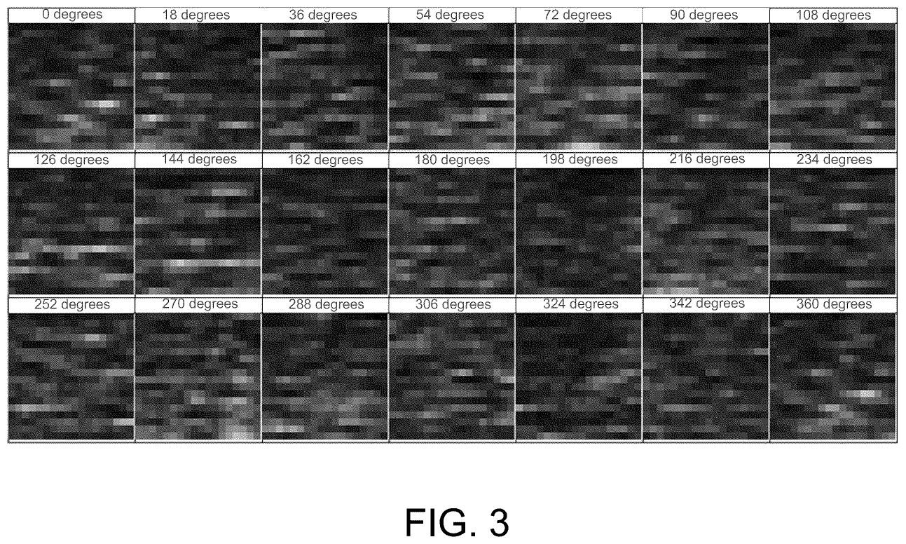

In one aspect, the shaft 90 is controlled to be rotated to an angle of a positioning point, and then the light sensor 13 is controlled to acquire an image frame IF at the angle, e.g., FIG. 3 showing that one image frame is acquired from a start point (e.g., shown as 0 degrees) and every 18 degrees, i.e. two positioning points be separated by 18 degrees, but not limited to 18 degrees. In another aspect, the shaft 90 is controlled to continuously rotate a whole cycle from the start point, and the image sensor 13 is controlled successively to acquire image frames IF at a frame rate. Then, equally-spaced image frames are selected as image frames corresponding to every positioning point according to a number of required positioning points.

The memory 17 includes a volatile memory and/or a non-volatile memory, and is used to record multiple image frames and/or image features of multiple positioning points (e.g., 20 positioning points being shown in FIG. 3, but not limited to 20) and associated buffer regions. It should be mentioned that the 0 degrees and 360 degrees in FIG. 3 are referred to the same angle of the shaft 90.

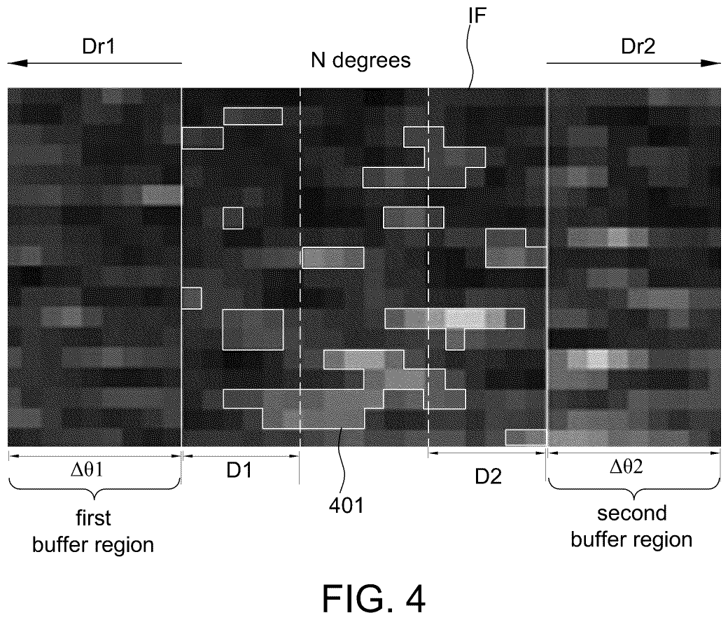

Please refer to FIG. 4, it is a schematic diagram of an image frame IF and an image feature to be recorded in a memory 17 of a light sensing device 100 according to one embodiment of the present disclosure. In one aspect, the image feature includes at least one of shapes, sizes and locations of a distribution pattern of binarization of one image frame. For example in FIG. 4, an image frame IF corresponding to an angle N degrees of the shaft 90 is shown, and a distribution pattern 401 includes multiple regions (respectively encircled by solid lines) having different shapes, sizes and locations. The multiple regions are determined, for example, when gray levels thereof are larger than a predetermined threshold or a gray level contrast is larger than a predetermined threshold, but not limited thereto. It is able to use the binarization method known to the art to determine the distribution pattern 401 without particular limitations. For example, the distribution pattern 401 includes multiple regions indicated by “1” or “0” after the binarization.

In addition, FIG. 4 further shows buffer regions associated with the image frame IF corresponding to the angle N degrees. The buffer regions include a predetermined angle region Δθ, e.g., 3 to 5 degrees, adjacent to each positioning point in a tangential direction Dr1 and Dr2 (e.g., Dr and a direction opposite to Dr in FIGS. 1-2) of the shaft 90. For example, the buffer regions include a first buffer region within a first predetermined angle range (e.g., N−Δθ1 to N) along a first tangential direction Dr1 of the shaft 90 and a second buffer region within a second predetermined angle range (e.g., N to N+Δθ2) along a second tangential direction Dr2 of the shaft 90. According to different applications, a transverse (e.g., left-right direction, corresponding to the tangential direction of the shaft 90, in FIG. 4) size of the first buffer region is different from that of the second buffer region. For example, when the shaft 90 is rotated by different rotation speeds in the first tangential direction Dr1 and the second tangential direction Dr2, a region of Δθ1 is different from that of Δθ2.

In one aspect, the image frame IF, the first buffer region and the second buffer region in FIG. 4 are recorded as one image feature associated with one positioning point.

The processor 15 is, for example, a digital signal processor (DSP), an application specific integrated circuit (ASIC), a field programmable gate array (FPGA) or the like that uses software, firmware and/or hardware to run functions thereof, e.g., including at least calculating rotation speed, calculating and comparing image features, outputting control signals. The processor 15 is used to compare, in an operating stage, a current image feature of a current image frame with multiple recorded image features to identify a current angle of the shaft 90. The method of calculating the current image feature is identical to that of calculating the multiple image features. The comparison is implemented by calculating, for example, similarity or correlation between the current image feature and the multiple recorded image features. When the similarity or correlation between the current image feature and one of the multiple recorded image features exceeds a comparison threshold, a current angle of the shaft 90 is identified.

In the present disclosure, the processor 15 further outputs a control signal Sctrl associated with a current angle to the computer 80, referring to FIG. 2. In addition, in order to allow the processor 19 to timely output the control signal Scrtl, the processor 15 further identifies that one current angle associated with one positioning point is detected after the first buffer region or the second buffer region associated with the one positioning point is detected and when a part of image features associated with the one positioning point close to a side of the first buffer region or the second buffer region is detected.

For example referring to FIG. 4 again, after the first buffer region is detected (by comparing the current image feature and an image feature of the first buffer region), the processor 15 identifies that a current angle N is detected when a part D1 of the image feature of the current angle N is detected. In this case, the shaft 90 rotates in the direction Dr1. Or, after the second buffer region is detected (by comparing the current image feature and an image feature of the second buffer region), the processor 15 identifies that a current angle N is detected when a part D2 of the image feature of the current angle N is detected. In this case, the shaft 90 rotates in the direction Dr2. In this way, the processor 15 identifies the current angle N before the whole of the image feature of the image frame IF is detected in comparison.

In one aspect, sizes of the part D1 and the part D2 in the tangential direction are adjusted (e.g., by the processor 15) corresponding to a rotation speed of the shaft 90. For example, when the rotation speed is larger, the sizes of the part D1 and the part D2 are larger; on the contrary, when the rotation speed is smaller, the sizes of the part D1 and the part D2 are smaller. In the operating stage, the processor 15 calculates the rotation speed according to successive current image frames, and the method of calculating the rotation speed is known to the art (e.g., comparing correlation between two current image frames), and thus details thereof are not described herein.

In comparing the current image feature and the multiple recorded image features in the operating stage, the processor 15 needs to compare the current image feature with all of the multiple recorded image features before any positioning point is identified. However, after one positioning point is identified, the processor 15 only compares the current image feature with those recorded image features close to the one positioning point (e.g., one or two image features prior to or behind the one positioning point) so as to reduce the computation.

The above aspect is described in the way that the light sensing device 100 is used to calculate the image feature and identify the current angle.

In another aspect, the light sensing device 100 is used to output multiple image frames IF corresponding to the start point and a whole cycle of the shaft 90 in the learning stage, wherein a number of the multiple image frames IF is determined according to a size of the shaft 90 and a frame rate of the light sensing device 100 for capturing the image frames IF. The computer 80 is used to divide/select multiple positioning points (e.g., referring to FIG. 3, but not limited to) and associated buffer regions according to an image frame of the start point and the frame rate, wherein a number of the positioning points is determined according to the required absolute positions. The computer 80 calculates and records multiple image features of every positioning point and associated buffer regions, wherein the method of calculating the image features of the positioning points and associated buffer regions by the computer 80 is identical to that calculated by the processor 15 mentioned above and thus details thereof are not repeated herein. In addition, the computer 80 may calculate the image features of the positioning points and associated buffer regions using algorithms or AI algorithms requiring higher computation than that used by the processor 15.

In the operating stage, the light sensing device 100 outputs (at a predetermined frame rate) current image frames. The computer 80 is used to compare current image features of current image frames and multiple image features (recorded in the learning stage) to identify a current angle of the shaft 90.

The present disclosure further provides an operating method of a light sensing system, which includes the light sensing device 100 and the computer 80, e.g., referring to FIG. 2, and the light sensing system is used to identify an absolute position/angle of the shaft 90. The operating method of the present disclosure includes a learning stage/phase and an operating stage/phase. In the learning stage, the light sensing system records multiple image features of multiple positioning points (e.g., FIG. 3 showing 20 positioning points, including a start point) and associated buffer regions (e.g., referring to FIG. 4) of the shaft 90. In the operating stage, the light sensing system compares a current image feature of a current image frame with the multiple recorded image features to identify a current angle of the shaft 90.

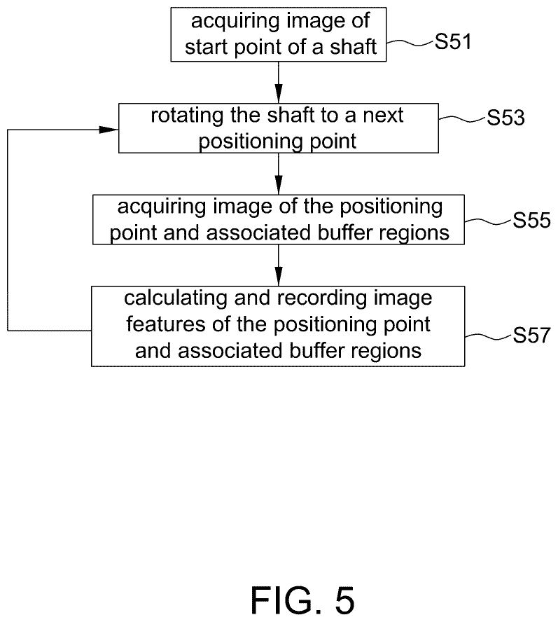

Please refer to FIG. 5, it is flow chart of an operating method in a learning stage of a light sensing device 100 according to a first embodiment of the present disclosure, wherein the current image feature and the multiple image features are generated by the light sensing device 100. The operating method includes:

Step S51: The light sensing device 100 (more specifically light sensor 13 thereof) acquires an image frame of a start point (e.g., 0 degrees or 360 degrees in FIG. 3) of the shaft 90.

Step S53: The draft 90 is rotated, manually or by a mechanical control, to a next positioning point, e.g., 18 degrees in FIG. 3, but not limited to 18 degrees.

Step S55: The light sensing device 100 (more specifically light sensor 13 thereof) acquires an image frame of the next positioning point and associated buffer regions, e.g., FIG. 4 showing an image frame IF at a degree of N and a first buffer region prior to the image frame IF as well as a second buffer region behind the image frame IF. The first buffer region and the second buffer region are respectively in the Mth image frame prior to and behind the image frame IF, wherein M is a positive integer value, which is determined by a rotation speed of the shaft 90. For example, when N is 0 degrees, the first buffer region covers an angle range between 355 degrees and 360 degrees (i.e. 0 degrees), and the second buffer region covers an angle range between 0 degrees and 5 degrees, wherein the angle ranges are arranged as fixed values or arranged as variable values determined according to a rotation speed 90 of the shaft. The first buffer region and the second buffer region include the whole of an image frame or a part of the image frame without particular limitations. In FIG. 4, the method of calculating image features of the first buffer region and the second buffer region is identical to that of calculating the image feature of the image frame IF.

Step S57: The light sensing device 100 (more specifically light sensor 13 thereof) calculates and records image features of every positioning point and associated buffer regions. As mentioned above, the image feature includes at least one of shapes, sizes and locations of a distribution pattern of binarization of one image frame, referring to the distribution pattern 401 shown in FIG. 4. It should be mentioned that the image feature used in the present disclosure is not particular limited as long as gray value features of every image frame is presented clearly.

If an image frame of 360 degrees is not detected, the process returns to the Step S53 and repeats the Steps S55 to S57 till the image frame of 360 degrees is detected such that image features of the whole cycle of the shaft 90 is recorded.

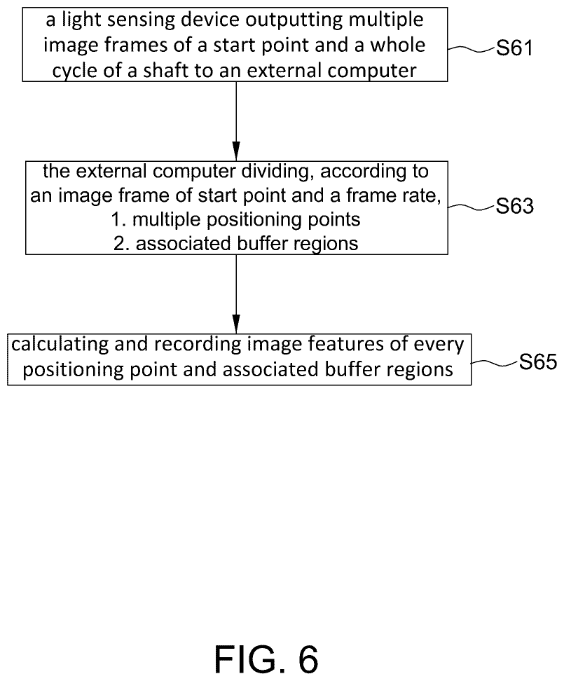

Please refer to FIG. 6, it is a flow chart of an operating method in a learning stage of a light sensing system according to a second embodiment of the present disclosure, wherein the current image feature and the multiple image features are generated by an external computer 80 according to image frames IF received from the light sensing device 100. The operating method includes:

Step S61: The light sensing device 100 outputs multiple image frames IF including a start point (e.g., 0 degrees in FIG. 3) and a whole cycle of the shaft 90 to the external computer 80, wherein a number of the multiple image frames IF is determined according to a size of the shaft 90 and a frame rate of the light sensing device 100 (more specifically light sensor 13 thereof).

Step S63: The external computer 80 (more specifically a processor thereof such as an MCU, a CPU or a GPU) divides/selects multiple positioning points and associated buffer regions in the received multiple image frames IF according to an image frame of the start point and the frame rate. Firstly, the external computer 80 identifies a range of the whole cycle of multiple image frames IF, i.e. identifying an image frame at 360 degrees, which is identical to that at 0 degrees. Next, the external computer 80 determines or selects the image frames among the multiple image frame IF that are used as positioning points, e.g., referring to FIG. 3, and associated buffer regions, e.g., referring to FIG. 4, according to a number of image frames between 0 degrees and 360 degrees and a desired number of positioning points.

Step S65: Next, the external computer 80 (more specifically the processor thereof) calculates and records (into a memory of computer 80) image features of every positioning point and associated buffer regions, e.g., referring to FIG. 4.

In another aspect, similar to the first embodiment, the light sensing device 100 of the second embodiment transmits only the image frames of every positioning point and within a predetermined angle range (e.g., 3 to 5 degrees) prior to and behind said every positioning point to the external computer 80. Other image frames are not transmitted.

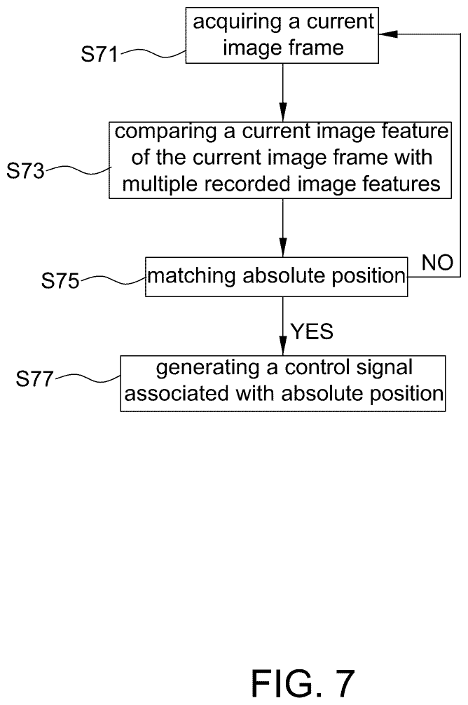

Please refer to FIG. 7, it is a flow chart of an operating method in an operating stage of a light sensing device and system according to one embodiment of the present disclosure. The operating method includes:

Step S71: The light sensing device 100 (more specifically light sensor 13 thereof) captures a current image frame of a current position/angle of the shaft 90.

Step S73: Next, the light sensing device 100 (more specifically light sensor 13 thereof) or the external computer 80 (the current image frame being sent to the external computer 80 at first) calculates a current image feature of the current image frame, and compares the calculated current image feature with multiple recorded image features, e.g., calculating similarity or correlation therebetween. In the aspect that the external computer 80 is used to perform the comparison and the external computer 80 has high calculation capability, the external computer 80 directly compares a current image frame with multiple recorded image frames, i.e. gray values of every pixel of the current image frame and the multiple recorded image frames being directly used as image features.

Step S75: When the similarity or correlation is higher than a comparison threshold, it means that the current image frame matches an absolute position of one positioning point, and thus a next step is entered. Otherwise, the process returns to the Step S71 to capture a new current image frame.

Step S77: In the aspect that uses the light sensing device 10 to perform the comparison, and after one absolute position is detected (match being hit) in the comparison, the light sensing device 100 outputs a control signal Sctrl associated with the absolute position to the external computer 80 for corresponding controls. In the aspect that uses the external computer 80 to perform the comparison, and after one absolute position is detected in the comparison, the external computer 80 directly performs a control corresponding to the absolute position, e.g., activating the operation of a display, a lamp, a vibrator, a speaker or other electronic devices depending on an application thereof.

As mentioned above, a response time of generating the control signal Sctrl is increased by further arranging buffer regions prior to and behind every positioning point.

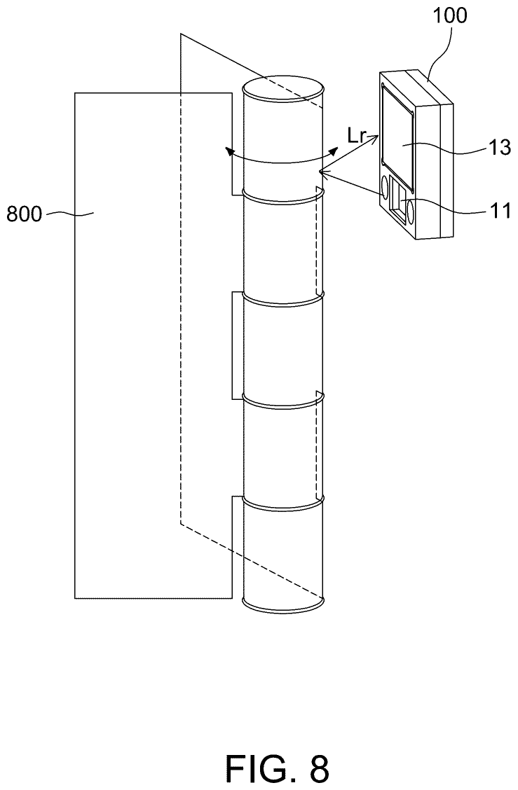

Please refer to FIG. 8, it is a schematic diagram of an application of a light sensing device according to one embodiment of the present disclosure. In FIG. 8, the light sensing device 100 is arranged opposite to a door hinge 800 as an example. However, the light sensing device 100 of the present disclosure may be adapted to detect any structure that is opened and closed using a hinge, e.g., a door hinge and a drawer hinge, as long as the structure includes a rotatable part (e.g., 90 shown in FIGS. 1 and 2) for the light sensing device 100 to capture a surface image thereof, and thus the structure is not limited to a hinge.

It should be mentioned that although the above embodiments are described in the way that the processor is used to calculate an image feature in a learning stage as an example, the present is not limited thereto. In other embodiments, an artificial intelligent (AI) engine is embedded in the processor to use AI algorithm (e.g., classification algorithm, but not limited to) to take image frames at different angles as learning data to build up and record a classification model and parameters in the learning stage. In the operating stage, the AI engine to categorize a current image frames into one of the different angles based on the classification model and parameters as a way to identify a current angle of the shaft. The present disclosure is not limited to obtaining image features as mentioned herein.

It should be mentioned that the values, e.g., including angles and numbers of positioning points, mentioned in the present disclosure are only intended to illustrate but not to limit the present disclosure.

It should be mentioned that the terms “prior to” and “behind” mentioned herein are determined by a rotation direction of the shaft 90.

As mentioned above, the conventional optical encoding needs to form marks having intensity higher than a required density on a working surface such that the application thereof is limited. Accordingly, the present disclosure further provides a light sensing device (e.g., referring to FIG. 1), a light sensing system (e.g., referring to FIG. 2) and an operating method thereof (e.g., FIGS. 5-7) that use any point on a surface under detection as a positioning point and generate multiple image features corresponding to multiple positioning points in a learning stage so as to identify a current angle in an operating stage according to a comparison result of a current image feature of a current image frame and multiple recorded image features. In the present disclosure, to improve a response time of generating a control signal, buffer regions are further arranged corresponding to each positioning point such that after the image features of the buffer regions are detected, a positioning point is confirmed to be detected by detecting only a part of image features of one positioning point.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A light sensing device, configured to identify an absolute position of a shaft, and comprising:
a light sensor, configured to acquire reflected light from the shaft to generate image frames; and
a memory, configured to record multiple image features of multiple positioning points of the shaft and associated buffer regions; and
a processor, configured to compare a current image feature of a current image frame with the multiple image features to identify a current angle of the shaft.

2. The light sensing device as claimed in claim 1, further comprising a light source configured to illuminate the shaft to generate the reflected light.

3. The light sensing device as claimed in claim 1, wherein the processor is further configured to output a control signal associated with the current angle to an external computer.

4. The light sensing device as claimed in claim 1, wherein the buffer regions include a predetermined angle region adjacent to each positioning point in a tangential direction of the shaft.

5. The light sensing device as claimed in claim 4, wherein
the buffer regions include a first buffer region within a first predetermined angle range along a first tangential direction of the shaft and a second buffer region within a second predetermined angle range along a second tangential direction of the shaft, and
a transverse size of the first buffer region is different from that of the second buffer region.

6. The light sensing device as claimed in claim 5, wherein the processor is further configured to
identify that the current angle associated with one positioning point is detected after the first buffer region or the second buffer region associated with the one positioning point is detected and when a part of image features associated with the one positioning point close to a side of the first buffer region or the second buffer region is detected.

7. The light sensing device as claimed in claim 6, wherein the processor is further configured to change a size of the part of image features in the tangential direction according to a rotation speed of the shaft.

8. The light sensing device as claimed in claim 1, wherein the current image feature and the multiple image features respectively include at least one of shapes, sizes and locations of a distribution pattern of binarization of one image frame.

9. A light sensing system, configured to identify an absolute position of a shaft, and comprising:
a light sensing device, configured to output multiple image frames acquired corresponding to a start point and a whole cycle of the shaft in a learning stage; and
a computer, arranged outside of the light sensing device, and configured to
divide multiple positioning points and associated buffer regions of the shaft according to an image frame associated with the start point and a frame rate, and
calculate and record multiple image features of every positioning point and associated buffer regions.

10. The light sensing system as claimed in claim 9, wherein
the light sensing device is further configured to output a current image frame in an operating stage, and
the computer is further configured to compare, in the operating stage, a current image feature of the current image frame with the multiple image features to identify a current angle of the shaft.

11. The light sensing system as claimed in claim 9, wherein the buffer regions include a predetermined angle region prior to or behind the every positioning point.

12. The light sensing system as claimed in claim 11, wherein
the buffer regions include a first buffer region within a first predetermined angle range prior to one positioning point and a second buffer region within a second predetermined angle range behind the one positioning point, and
a transverse size of the first buffer region is different from that of the second buffer region.

13. The light sensing system as claimed in claim 12, wherein the computer is further configured to
identify that the current angle associated with the one positioning point is detected after the first buffer region or the second buffer region associated with the one positioning point is detected and when a part of image features associated with the one positioning point close to a side of the first buffer region or the second buffer region is detected.

14. The light sensing system as claimed in claim 13, wherein the computer is further configured to
calculate a rotation speed according to multiple current image frames, and
adjust a size of the part of image features in a tangential direction of the shaft according to the rotation speed.

15. The light sensing system as claimed in claim 9, wherein each of the multiple image features includes at least one of shapes, sizes and locations of a distribution pattern of binarization of one image frame.

16. An operating method of a light sensing system, the light sensing system comprising a light sensing device and an external computer, and configured to identify an absolute position of a shaft, the operating method comprising:
entering a learning stage to record multiple image features of multiple positioning points and associated buffer regions of the shaft; and
entering an operating stage to compare a current image feature of a current image frame with the multiple image features to identify a current angle of the shaft.

17. The operating method as claimed in claim 16, wherein the current image feature and the multiple image features are generated by the light sensing device.

18. The operating method as claimed in claim 16, wherein the current image feature and the multiple image features are generated by the external computer according to image frames received from the light sensing device.

19. The operating method as claimed in claim 16, wherein the buffer regions include a predetermined angle region adjacent to each positioning point in a tangential direction of the shaft.

20. The operating method as claimed in claim 16, wherein the current image feature and the multiple image features respectively include at least one of shapes, sizes and locations of a distribution pattern of binarization of one image frame.
